(19) United States
(12) Patent Application Publication
(10) Pub. No.: US 2017/0206798 A1
(43) Pub. Date: Jul. 20, 2017

(54) Virtual Reality Training Method and System

(71) Applicant: Compedia Software and Hardware Development Ltd., Ramat Gan (IL)

(72) Inventor: Shai Newman, Rosh-Ha'Ayin (IL)

(21) Appl. No.: 15/401,046

(22) Filed: Jan. 8, 2017

Related U.S. Application Data
(60) Provisional application No. 62/279,781, filed on Jan. 17, 2016.

(51) Int. Cl. G09B 9/00; H04N 13/02; G06F 3/01; H04N 13/04; G09B 9/46; G06T 19/00

(52) U.S. Cl. CPC G09B 9/00; G09B 9/46; G06T 19/003; G06F 3/012; H04N 13/044; H04N 13/0468; H04N 13/0497; H04N 13/0239; H04N 2213/008

(57) ABSTRACT

A virtual realm system provides a trainee with an experience of a journey within a virtual world. A trainer steers the trainee's continuous journey within the virtual world, the journey rendering an imaginary continuous path within the virtual world. The trainee continually views the virtual world during the journey, using stereoscopic goggles that show the virtual world as seen from the trainee's current location dynamically determined by the trainer within the virtual world and an orientation determined by the current real-world orientation of a headset that includes the goggles and is worn by the trainee.

### BACKGROUND OF THE INVENTION

Field of the Invention

The present invention relates to virtual reality, and in particular to virtual reality applied for training and guidance.

Description of Related Art

Virtual reality is a computer-simulated reality that replicates users' presence in places in the real world or an imagined world, allowing the users to explore, and, in some implementations, interact, with that world. Virtual reality is based on artificially creating sensory experiences, primarily sight and hearing and possibly also touch and/or smell. Often, special-purpose headsets are worn by users to provide stereoscopic images and sound, for offering a lifelike experience.

Virtual reality has found many applications, such as in games and movies for entertainment, in education, or in professional or military training.

### BRIEF SUMMARY OF THE INVENTION

The following description relates to guiding a junior user by a senior user during a virtual journey. The term “trainer” relates the senior user, and means a trainer within a training session, a tutor within an educational session, a tour guide within a sightseeing session, a guide in a museum visit, and the like. Similarly, the term “trainee” relates to the junior user, and means a trainee, a student, a tourist, a visitor, or the like, respectively.

The present disclosure seeks to provide systems and functionalities for a trainee experiencing a journey within a virtual world. A trainer steers a journey of the trainee within the virtual world, the journey thereby rendering a continuous imaginary path within the virtual world. The term “steer” implies herein choice by the trainer as to where to position the trainee at any given moment, which further determines the imaginary path rendered by the journey as well as the (possibly varying) speed, and possibly stop points, along the path. For the realistic trainee's experience, steeling is constrained by continuity of the imaginary path rendered by the journey and by the journey being reasonably associated with the training environment, such as being made along free areas on the ground or floor of the virtual world, or allowing flying above the ground, for example when training helicopter pilots. The trainee wears a virtual reality headset that includes stereoscopic goggles that provide a stereoscopic view into the virtual world. To enhance the realistic experience and training effectiveness, the user is free to turn his head, thereby determining the orientation of the virtual reality headset within the real-world space in which the trainee is located, which orientation is detected by orientation sensors. An image generator generates a pair of images displayed on two screens within stereoscopic goggles that form part of the trainee's headset, offering the trainee a stereoscopic view into the virtual world as seen from the current location within the virtual world and according to the current orientation of the virtual reality headset within the real-world, which determines the current orientation of the trainee's head within the virtual world. By repeatedly displaying the images as viewed from different successive locations along the journey's path, the trainee is provided with an experience of realistically traveling within the virtual world, along a continuous path as steered by the trainer.

There is thus provided, in accordance to preferred embodiments of the present invention, a training system that includes:
at least one nonvolatile storage device storing a digital representation of a three-dimensional virtual world;
a virtual reality headset wearable by a trainee, the virtual reality headset including stereoscopic goggles for displaying a pair of computer-generated images in order to provide the trainee with a stereoscopic viewing experience;
orientation sensors for reading a current orientation of the virtual reality headset within a real-world space in which the trainee is located;
a trainer console configured to allow a trainer to steer a virtual journey of the trainee within the virtual world, the journey thereby rendering an imaginary continuous path within the virtual world; and
an image generator programmed to:
   retrieve a current location of the trainee within the virtual world,
   receive from the orientation sensors the current orientation of the virtual reality headset,
   generate the pair of computer-generated images for providing the trainee with a stereoscopic view at the virtual world as seen from the current location within the virtual world and according to an orientation determined by the current orientation of the virtual reality headset, and
   repeat the retrieve, receive and generate steps a plurality of times for different successive locations along the path rendered within the virtual world for providing the trainee with an experience of realistically traveling within the virtual world.

The trainer console may allow the trainer to selectably steer the journey toward a vicinity of a selected element selected by the trainer. Furthermore, the training system may include a communication channel between the trainer console and the virtual reality headset, and the trainer console may further allow the trainer to use the communication channel for visually distinguishing the selected element within the virtual world and for narrating the selected element.

The training system may allow traveling within a virtual world that includes an operable object; and the trainer console may further allow the trainer to operate the operable object. Moreover, the training system may further include a trainee control, that forms part of the headset or is separate from the headset, that allows the trainee to operate the operable object.

The orientation sensors may be based on at least one of: a gyroscope included in the virtual reality headset; a camera included in the virtual reality headset for capturing visual features within a real space accommodating the trainee; or cameras positioned within a real space accommodating the trainee and observing visual features on the virtual reality headset or trainee's head.

The digital representation of the three-dimensional virtual world may form part of at least one of: the virtual reality headset; the trainer console; or a server that communicates with the virtual reality headset and the trainer console. The image generator may be included in at least one processor of at least one of: the virtual reality headset; the trainer console; or a server that communicates with the virtual reality headset and the trainer console.

### DETAILED DESCRIPTION OF PREFERRED EMBODIMENTS OF THE INVENTION THE SYSTEM

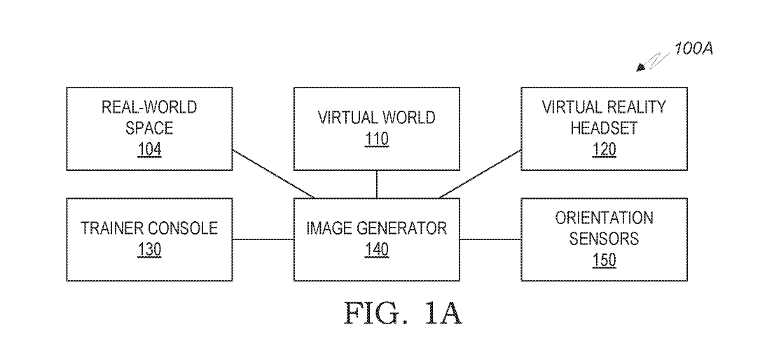

Reference is made to FIG. 1A that shows an abstraction of a system 100A according to a preferred embodiment of the present invention. Virtual world 110 is one or more nonvolatile storage devices that store a digital representation of a three dimensional victual scene, such as a virtual room, virtual objects within the room, and light sources. Virtual worlds are common in the art of virtual reality and are based on 3D models that are created by tools like Autodesk 3ds Max by Autodesk, inc. and other similar tools. The 3D models are then usually loaded into 3D engines, such as Unity3D by Unity Technologies, or Unreal by Epic Games. Such engines enable to use the 3D models of virtual worlds and add to them lighting and additional properties and then render an image as seen from a specific location and point of view using technologies like ray tracing, that enable to build an image of the virtual world as it is seen from a specific location and point of view. Also know in the art is the technology of a virtual camera that is placed in a specific location in the virtual world and is given an orientation as well as camera parameters, like field of view, which cause the 3D engine to generate an image as seen from that virtual camera. Stereoscopic view is implemented by placing two virtual cameras, one for each eye, usually at the distance of about 6 cm from each other. The above are standard practices of offering virtual world experience and there are numerous code packages and SDKs that enable professionals to build and manipulate complex virtual worlds.

Virtual reality headset 120 is a common virtual reality headset wearable by a trainee to provide the trainee with a realistic experience of having a journey within the virtual world. An example for such headsets are Gear VR by Samsung Electronics on which a standard compatible smartphone is mounted or Oculus Rift by Oculus VR that is connected to a personal computer. Real-world space 104 is the actual physical space, such as a room and a chair, in which that trainee is located during training. Orientation sensors 150 read the three-dimensional angular orientations of the virtual reality headset within the real-world space.

Trainer console 130 allows a trainer to steer a journey of the trainee within the virtual world, to resemble an experience of a common journey in the real world. Thus, the current location of the trainee within the virtual world is continually determined by the trainer via trainer console 130. Trainer console 130 may also be used by the trainer to operate operable objects within virtual world 110, as will be further depicted later below. Image generator 140 is one or more processors programmed to continuously: retrieve from trainer console 130 the current location of the trainee within the virtual world; receive from orientation sensors 150 the current orientation of virtual reality headset 120 within the real-world space 104; and generate a pair of images to be displayed to the trainee by goggles that form part of virtual reality headset 120.

FIGS. 1B is a block diagram of a system 100B, depicting several preferred embodiments of the present invention. The following description is made with reference to both FIGS. 1A-1B.

Virtual reality headset 120 includes stereoscopic goggles 120E that provide the trainee with stereoscopic view of the virtual world, and may also include an audio component, such as headphones, to supply an audio track as well as form part of an audio channel between the trainer and trainee. It would be noted, however, that under some training scenarios, the trainer and trainee may be physically close enough in the real-world space 104 to allow natural speaking to provide the audio channel, thereby obviating the need for an electronic audio component within stereoscopic goggles 120G. Processor 120P includes processing circuitry and programs that control the operation of other units of virtual reality headset 120, and preferably operates as image generator 140A to execute all or part of the functions of image generator 140 of FIG. 1A described above. It will be noted that program code executed by processor 120P may be stored as part of the processor and/or stored in and read from nonvolatile memory 120M. Nonvolatile memory 120M may include program code to be executed by processor 120P, and data used or collected by other units of virtual reality headset 120. Preferably, nonvolatile memory 120M includes data of virtual world 110A, which is a complete or partial copy of virtual world 110 of FIG. 1A. Optional gyroscope 150G detects angular acceleration of virtual reality headset 120 to determine the current orientation of the headset, thereby providing all or part of the functions of orientation sensors 150 of FIG. 1A. Additionally or alternatively, orientation sensors 150 my be implemented by optional camera 150B in cooperation with visual features 1501) or by camera 15013 being a 3D camera. In the first case, the system is trained to recognize and select visual features 150D in the real world space 104 as trackers, and use visual computing in order to identify these trackers' position and orientation relatively to the camera 150B, for example by using common software libraries such as AR-ToolKit by Dari. Alternatively, by using a three-dimensional camera, such as Real-Sense by Intel, the camera may identify a known room structure, for example position of walls, and infer the camera position and orientation using SDKs such a Real-Sense SDK by Intel. Visual features 150D, that are inherent to the construction of virtual reality headset 120 or are especially marked for forming part of orientation sensors 150, cooperate with cameras 150E as another implementation of orientation sensors 150 of FIG. 1A Trainee controls 120C, such as keypads, touchpads, game controllers or accelerometers that either form part of the VR headset or are separate devices (not described in the figures) may be included in order to allow the trainee to operate operable objects within virtual world 110; also, such trainee controls may be implemented, in alternative embodiments, in a different way, such as by interpreting hand movements of the trainee's hands according to images captured by cameras 150E within the real-world space 104. Wireless communication 120W, such as a Wi-Fi or Bluetooth unit, is usable by virtual reality headset 120 for communicating with trainer console 130 and optionally also with server(s) 160 and cameras 150E of real-world space 104. It will be noted that in some embodiments, wireless communication 120W may be replaced in all or in part by wired communication.

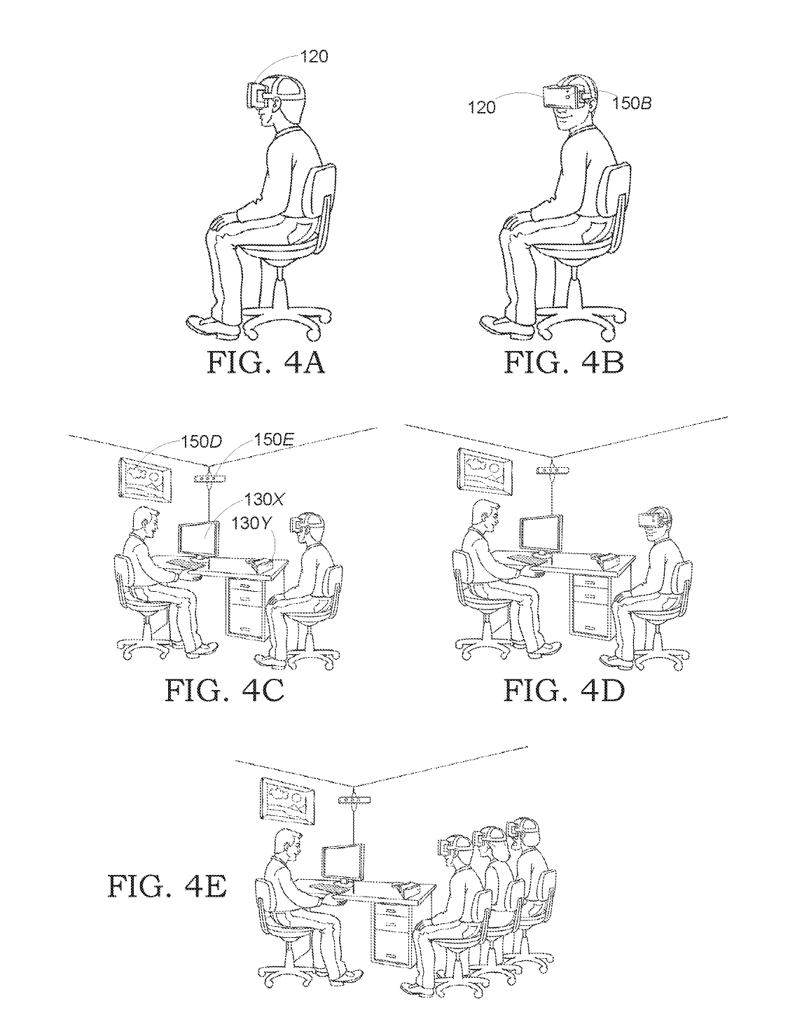

Trainer console 130 includes trainer controls 130C, such as a keyboard, mouse, keypad, trackpad, touchpad, game controller, accelerometers, or controls included as part of a trainer virtual reality headset—if the trainer uses such headset (trainer headset 130Y in FIG. 4C), for allowing the trainer to operate trainer console 130. Processor 130P includes processing circuitry and programs that control the operation of other units of trainer console 130, and preferably operates as image generator 140B to execute all or part of the functions of image generator 140 of FIG. 1A described above. It will be noted that program code executed by processor 130P may be stored as part of the processor and/or stored in and read from nonvolatile memory 130M. Nonvolatile memory 130M may include program code to be executed by processor 130P, and data used or collected by other units of trainer console 130. Preferably, nonvolatile memory 130M includes data of virtual world 110B, which is a complete or partial copy of virtual world 110 of FIG. 1A. Screen 130S complements trainer controls 130C in operating trainer console 130, and may also be used to monitor the various operations of and data acquired by virtual reality headset 120. Audio 130A such as a microphone and speaker or headphones allow the trainer to verbally communicate with the trainee via virtual reality headset 120, and wireless communication 13GW, such as a or Bluetooth unit (or, alternatively, a wired connection), is usable by trainer console 130 for communicating with virtual reality headset 120 and optionally also with server(s) 160.

Real-world space 104 accommodates the trainee wearing virtual reality headset 120, and optionally includes inherent and/or marked visual features 150D that are captured by camera 15013 of virtual reality headset 120 as an embodiment of orientation sensors 150 of FIG. 1A; or optional cameras 150E are situated within real-world space 104 to capture the visual features 150C of virtual reality headset 120 as another alternative embodiment of orientation sensors 150 of FIG. 1A. Processor 104P may be included to process images captured by cameras 150E and transform them to headset orientation data. Wireless communication 104W (and/or a wired connection) is included in real-world space 104 if cameras 150E and/or processor 104P are included, to send images and/or headset orientation data to image generator 140.

Server(s) 160 are optionally included to undertake storage, communication and processing tasks that may otherwise be performed by the respective storage devices and processors of virtual reality headset 120 and trainer console 130. Server(s) 160 may be one or more computing devices that are separate from both virtual reality headset 120 and trainer console 130, such as a personal computer located within or next to real-world space 104, or a remote computer connected via a local network or the Internet. Processor(s) 160P may include image generator(s) 140C that undertake all or part of the tasks of image generator 140 of FIG. 1A, in cooperation with or instead of image generator 140A and/or image generator 140B. Nonvolatile memory 160M may store virtual world 110C that is a complete or partial copy of virtual world 110 of FIG. 1A, in addition to or instead of virtual world 110A and virtual world 110B virtual reality headset 120 and trainer console 130, respectively. Wireless communication 160W (and/or a wired connection) is a communication unit for communicating, as needed, with virtual reality headset 120, trainer console 130 and optionally also with cameras 150E or processor 104P.

### Operation

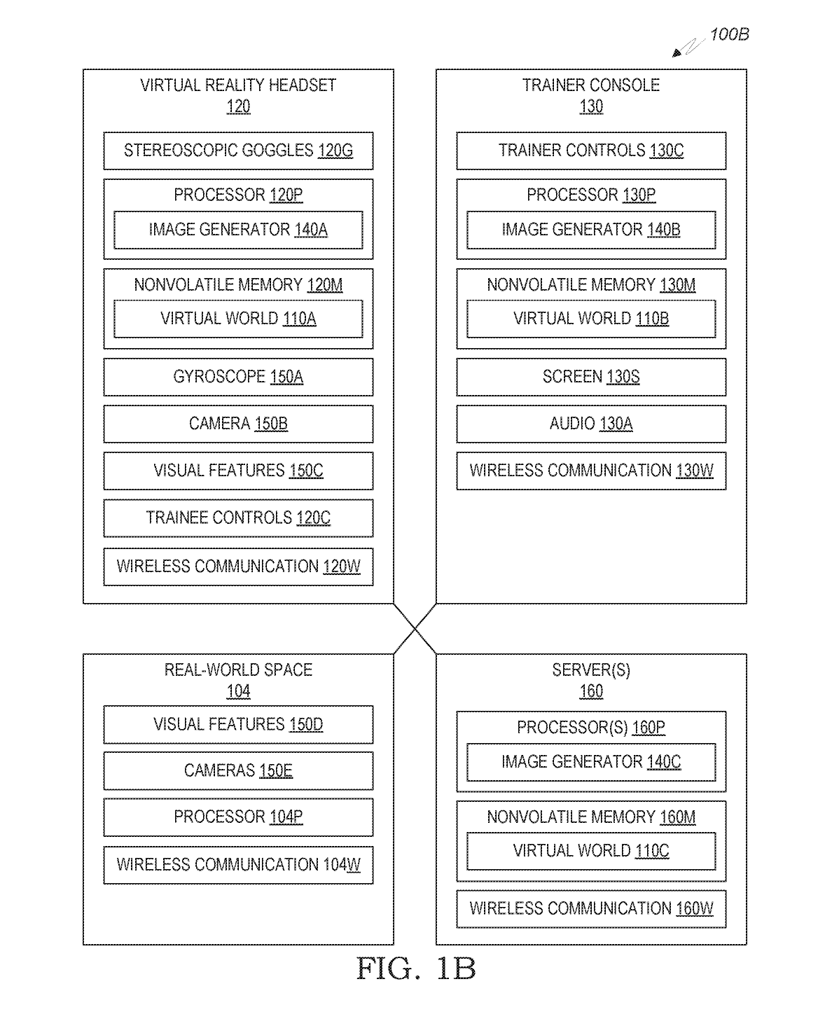

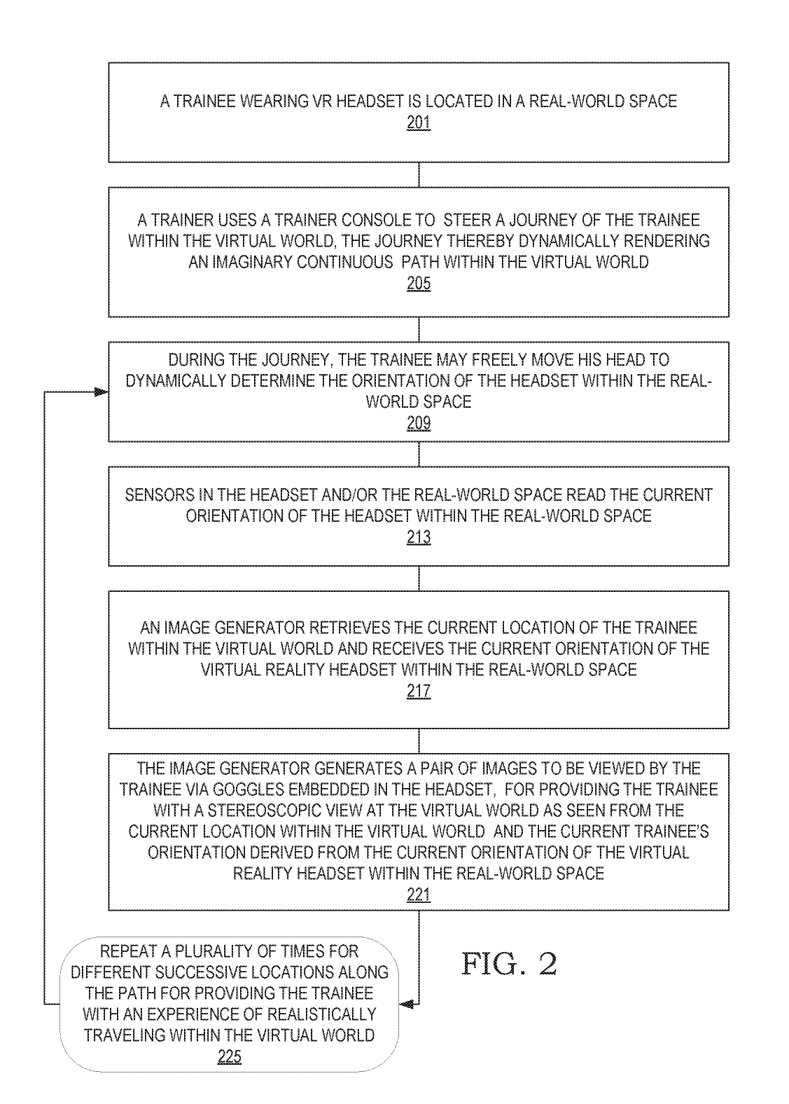

Reference is now made to FIG. 2, which is a flowchart of the operation of a preferred embodiment of the present invention. In step 201 a trainee wearing a virtual reality headset 120 is located in real-world space 104, such as seating on a chair in a room. In step 205, a trainer uses a trainer console 130 to steer a journey of the trainee within virtual world 110, the journey thereby rendering an imaginary continuous path within the virtual world 110. Step 209 is executed during the trainee's journey in virtual world 110, where the trainee may freely move his head to change the three-dimensional orientation of virtual reality headset 120 within real-world space 104. In step 213, orientation sensors 150, that are actually implemented as gyroscope 150A, camera 150B, visual features 150C, visual features 150D and/or cameras 150E within virtual reality headset 120 and/or real-world space 104, continually read the current orientation of virtual reality headset 120 within real-world space 104. In step 217, image generator 140, that is actually implemented as image generator 140A, image generator 140B and/or image generator 140C within processors of virtual reality headset 120, trainer console 130 and/or server(s) 160, respectively, retrieves, preferably from trainer console 130, the current location of the trainee within virtual world 110 and receives from orientation sensors 150 the current orientation of virtual reality headset 120 within real-world space 104. In step 221, image generator 140 generates a pair of images to be viewed by the trainee via stereoscopic goggles 120G that form part of virtual reality headset 120, for providing the trainee with a stereoscopic view at the virtual world 110 as seen from the current location within virtual world 110 and an orientation determined by the current orientation of the virtual reality headset 120 with respect to real-world space 104. Step 225 loops between steps 209-221 a plurality of times for different successive locations along the imaginary path, to provide the trainee with an experience of realistically traveling within the virtual world 110.

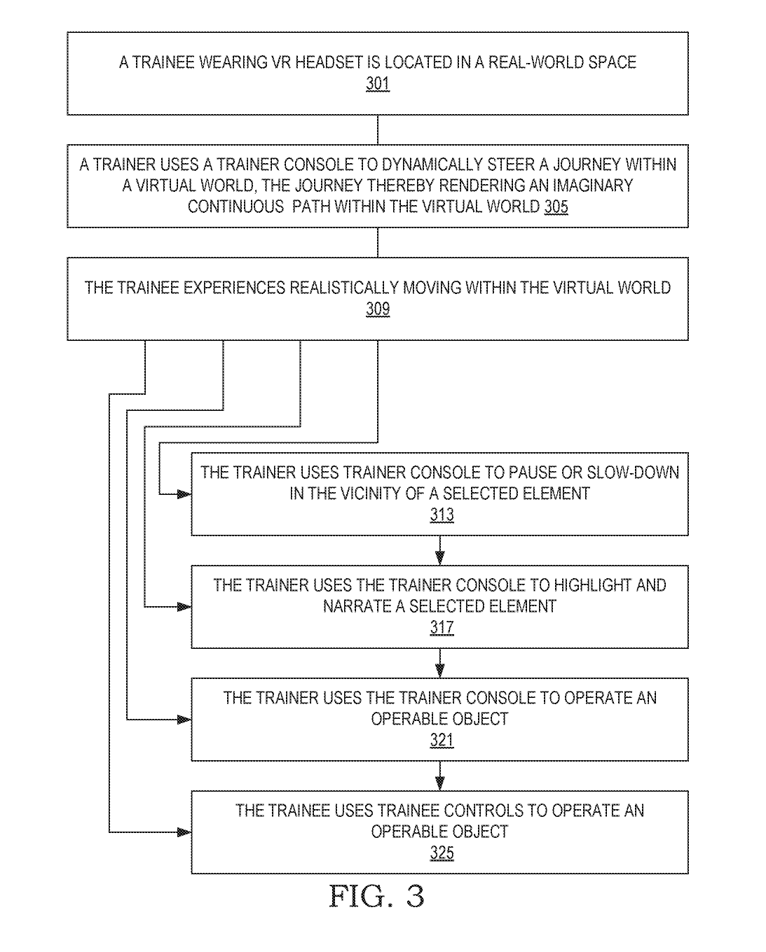

FIG. 3 is a flowchart presenting options that may be added to the operation of FIG. 2. Step 301 and step 305 are identical to step 201 and step 205, respectively, while step 309 summarizes steps 209-225 of FIG. 2 and their outcome—i.e. the trainee experiencing realistically traveling within the virtual world 110. Steps 313-325 depict options that can be executed, independently or serially and in any order. In step 313, the trainer uses trainer console 130 for steering the trainee's journey to pause or slow-down in the vicinity of a selected element (such as object or location) within the virtual world, for example in order to narrate or operate the selected element or allow the trainee to operate the selected element. In step 317, the trainer uses trainer console 130 to highlight a selected object or location within the virtual world 110, for example, by adding to the pair of images displayed by stereoscopic goggles 120G a marker, such as a bright or colored light spot on or next to the displayed image of the selected object or location. Additionally or alternatively, distinguishing or drawing attention to a selected element, especially when the selected element is out of the trainee's current field-of-view, may be made by rendering an imaginary pointer, such as a three-dimensional arrow within the virtual world, pointing at the selected element. The position, orientation and length of such arrow may be determined by selecting, within the virtual world, an arbitrary point in front of the trainee, calculating the direction between the arbitrary point and the selected element, and rendering within the virtual world a three-dimensional arrow that starts at the arbitrary point, is directed according to the calculated direction, and its length is wholly visible within the trainee's current field-of-view. Such highlighting will be further discussed below. In step 321, the trainer uses trainer console 130 to operate an operable object, for example to open a virtual emergency door. In step 325, the trainee uses trainee controls 1200, implemented within or separately from virtual reality headset 120, for operating an operable object, under the trainer instruction or by the trainee's initiative.

### The Real-World Space

FIGS. 4A-4E illustrate an example of several views at a real-world space 104 of FIGS. 1A-113, where the trainer and trainee are physically located during training. FIG. 4A the trainee, wearing a virtual reality headset 120 is seating on a chair, looking forward. In FIG. 4B, the trainee has turned his head, by his own initiative or following an instruction from the trainer, to the left, which caused a respective change in the orientation of virtual reality headset 120, detected by orientation sensors 150 (FIG. 1A). Also shown in FIG. 4B is camera 150B that cooperates with visual features within real-world space 104 to act as an orientation sensor. FIG. 4C expands the illustration of FIG. 4A, to show also part of the room, the trainer, trainer computer 130X and trainer headset 130Y that may serve as trainer console 130 of FIGS. 1A-1B. Also shown are a painting on the wall that may serve as one of visual features 150D that cooperate with the trainee's headset camera 150B to serve as an orientation sensor 150, and camera 150E that may cooperate with other cameras 150E in the room to track visual features on the trainee's virtual reality headset 120 or head, as another one of orientation sensors 150. Camera 150E may also capture gestures made by the trainee's hands to serve as a trainee controls 120C. FIG. 4D depicts a snapshot of the training session of FIG. 4C, where the trainee has tuned his head, along with virtual reality headset 120, according to FIG. 4B. FIG. 4E demonstrates a scenario of group training, where a trainer uses his training console for training a plurality of trainees three in the example of FIG. 4E—each wearing his or her own headset. FIGS. 4C-4E also demonstrate that the audio channel between the trainer and the trainee(s) used for narrating selected elements and generally providing guidance may be based on natural sound rather than electronic communication, thereby obviating, in some embodiments, the need for an audio component in virtual reality headset 120.

The Virtual World

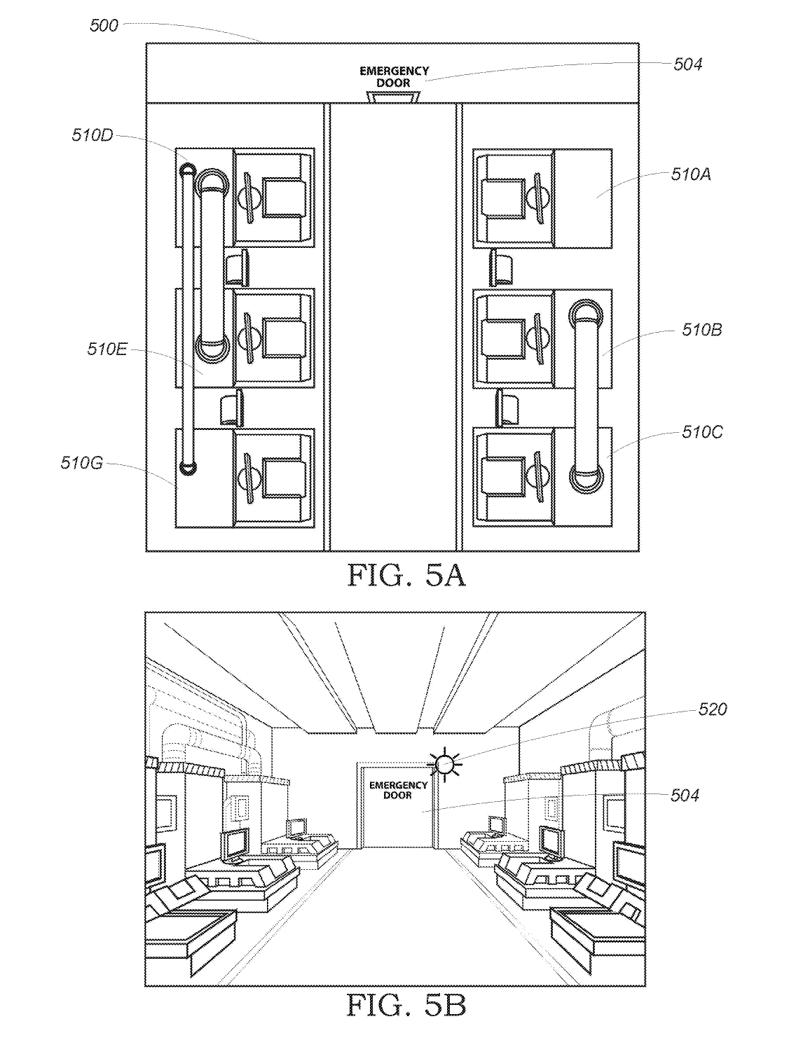

FIGS. 5A-10B demonstrate the concept of virtual world 110 (FIG. 1A) in which the trainee wearing a virtual reality headset experiences a journey steered by the trainer. It will be noted that during the journey the trainee is moved by the trainer so that the journey renders an imaginary continuous path within the virtual world, similarly to in real-world journeys. The trainer may selectively slow down or momentarily pause the trainee's journey next to selected elements, for example for narrating such elements.

In FIG. 5A, virtual world 500 is represented by a manufacturing floor that includes six workstations 510A-510G, and an emergency door 504 that represents a special element selected by the trainer for training. FIG. 5B shows a view of virtual world 500 as seen from the entrance, and demonstrates a marker 520, such as a bright light spot, that the trainer may selectively turn on to highlight and distinguish emergency door 504, or other elements within virtual world 500 selected by the trainer.

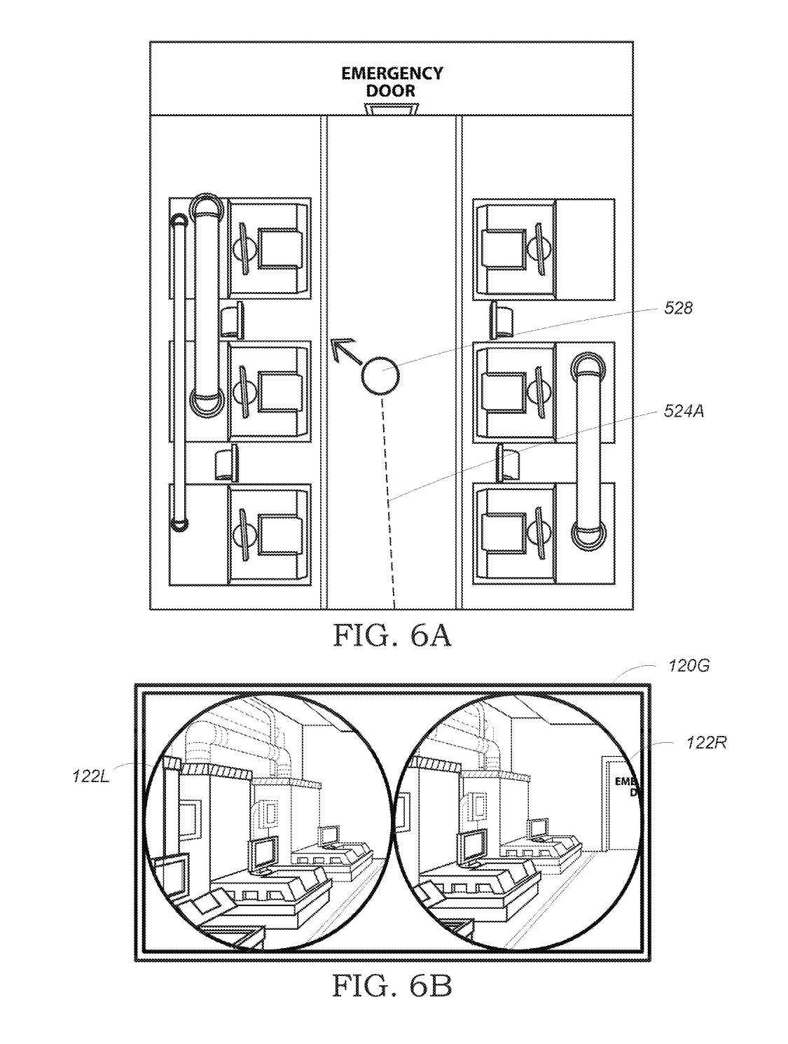

FIG. 6A shows a snapshot of the journey, of a trainee that has been steered by the trainer from the entrance toward the middle of the manufacturing floor's corridor, as demonstrated by imaginary path 524A. Trainee 528 represents the trainee's head oriented as shown by the arrow, which orientation is determined by the actual orientation of the trainee's head and headset in the real-world, as demonstrated by FIGS. 4A-4D. It will thus be appreciated that the trainee's current position is determined in the real-world by the trainer via the trainer console, while the trainee's head orientation is determined by the actual head orientation of the trainee in the real-world. At the point demonstrated by FIG. 6A, the trainee may be moving at any speed selected by the trainer, including slowing down or pausing next to elements that the trainer decides to emphasize, operate or narrate.

FIG. 6B illustrates computer-generated images shown by left-hand screen 122L and right-hand screen 122R that for part of stereoscopic goggles 120G worn by trainee 528 in the scenario of FIG. 6A. It will be appreciated that the images shown in FIG. 6B represent a snapshot within a continuum of images that dynamically change as determined in the real-world by the trainer's console and trainee's headset.

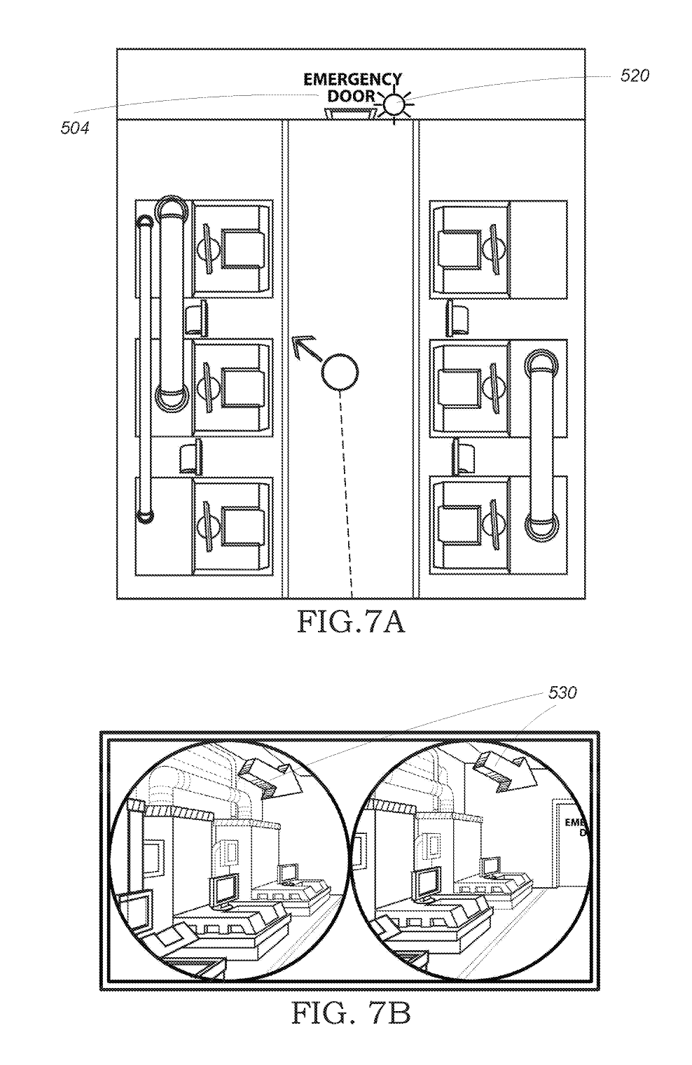

FIGS. 7A-7B extend the scenario of FIGS. 6A-6B by the trainer using trainer console 130 (FIGS. 1A-1B) to highlight and draw the attention of the trainee to a selected element emergency door 504 in the present example. Marker 520 is turned on by the trainer, yet is currently still out of the field of view of the trainee, so the trainer uses trainer console 130 to position pointer 530 that points toward emergency door 504, and may also use his natural voice or electronic communication, for guiding the trainee, in the real world, to notice the emergency door 504 in the virtual world.

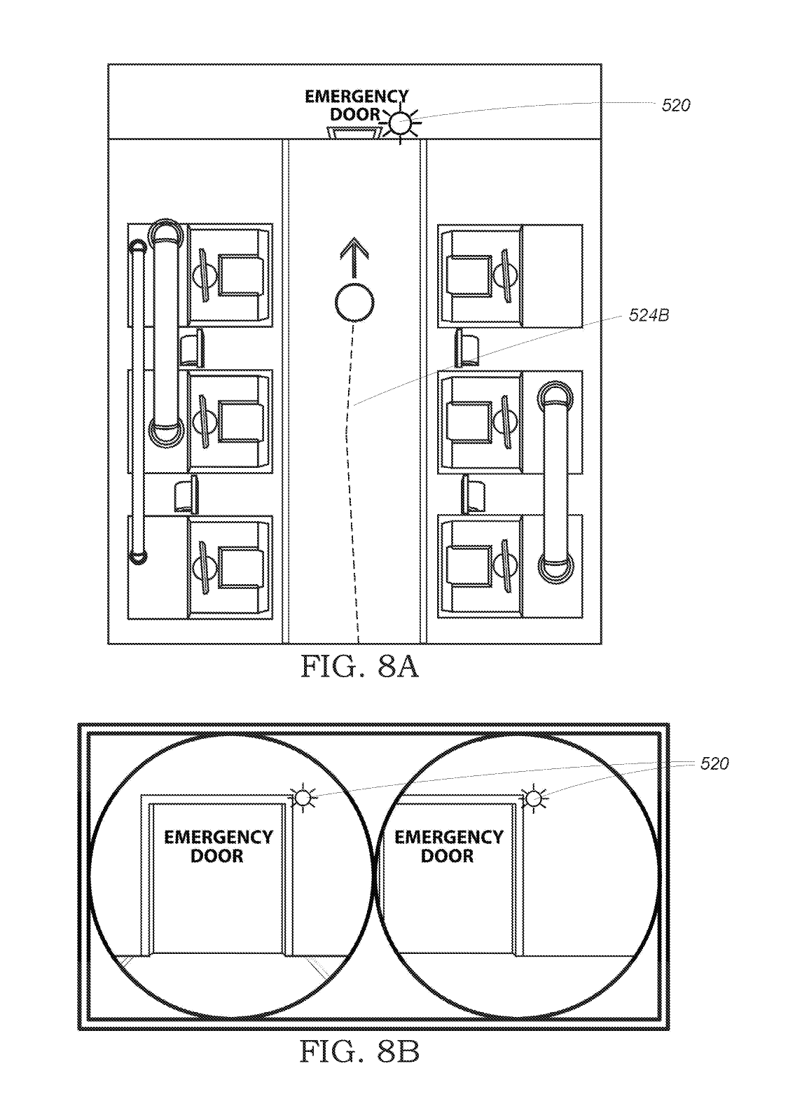

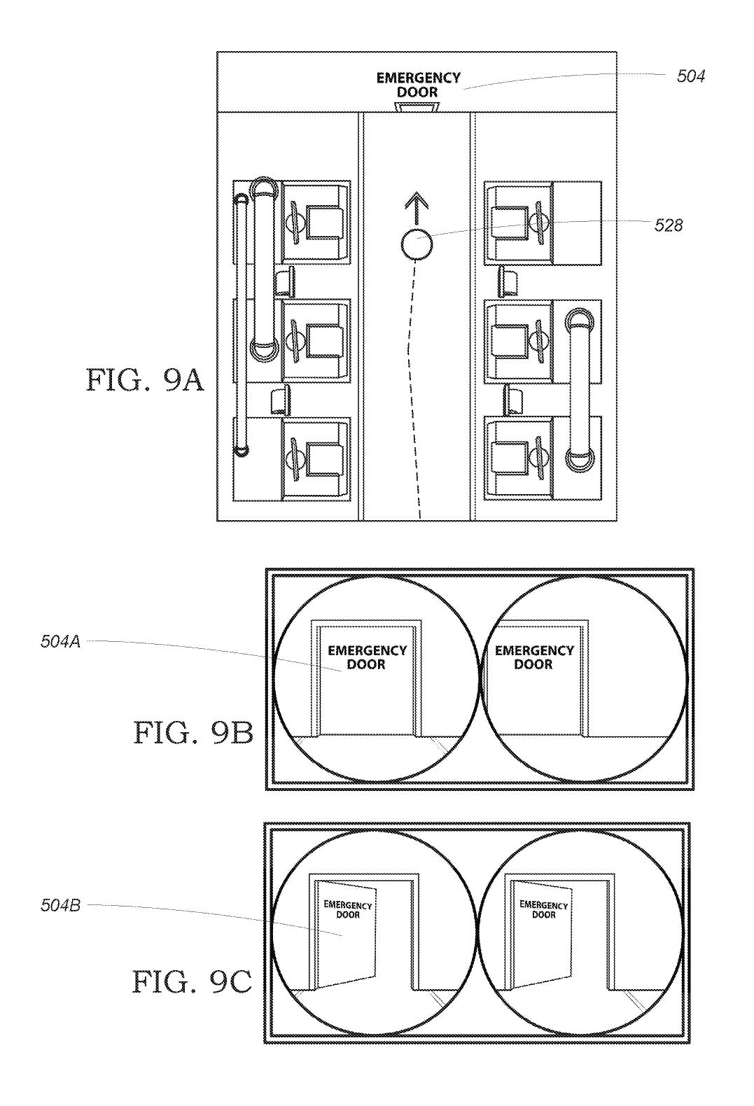

FIG. 8A illustrates the trainee moved by the trainer toward the emergency door, which also extends continuous imaginary path 524B, with the result of a closer trainee's look at the marked door illustrated in FIG. 8B. In FIG. 9A, still from the viewpoint of FIG. 8A, the marking is turned off by the trainer, which results with the image of the now-unmarked emergency door 504A shown in FIG. 913. Under the present exemplary scenario, emergency door 504A is an operable object, that can be opened or closed by the trainer using trainer controls 130C, or by the trainee using trainee controls 120C (FIG. 1B).

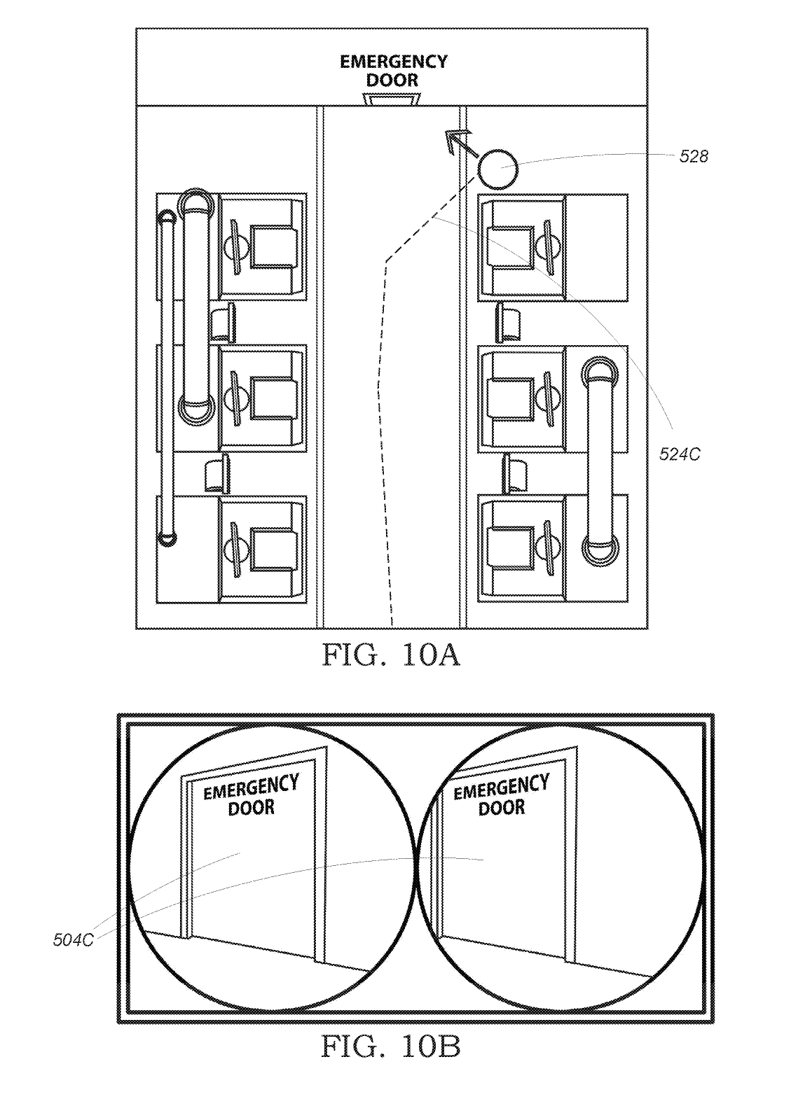

FIGS. 10A-10B show the trainee being further relocated by the trainer, which further extends imaginary path 524C, with emergency door 504C demonstrating the stereoscopic image seen by the trainee from the current location determined by the trainer and current head position determined by the trainee.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A training system comprising:
at least one nonvolatile storage device storing a digital representation of a three-dimensional virtual world;
a virtual reality headset wearable by a trainee, the virtual reality headset including stereoscopic goggles for displaying a pair of computer-generated images in order to provide the trainee with a stereoscopic viewing experience;
orientation sensors for reading a current orientation of the virtual reality headset within a real-world space in which the trainee is located;
a trainer console configured to allow a trainer to steer a virtual journey of the trainee within the virtual world, the journey thereby rendering an imaginary continuous path within the virtual world; and
an image generator programmed to:
retrieve a current location of the trainee within the virtual world,
receive from the orientation sensors the current orientation of the virtual reality headset,
generate the pair of computer-generated images for providing the trainee with a stereoscopic view at the virtual world as seen from the current location within the virtual world and according to an orientation determined by the current orientation of the virtual reality headset, and
repeat said retrieve, receive and generate steps a plurality of times for different successive locations along the path rendered within the virtual world for providing the trainee with an experience of realistically traveling within the virtual world.

2. The training system of claim 1, wherein the trainer console allows the trainer to selectably steer the journey toward a vicinity of a selected element selected by the trainer.

3. The training system of claim 1, further comprising a communication channel between the trainer console and the virtual reality headset, and wherein the trainer console further allowing the trainer to use the communication channel for visually distinguishing the selected element within the virtual world and for narrating the selected element.

4. The training system of claim 3, wherein the visually distinguishing is made by rendering a three-dimensional arrow that is visible to the trainee and is pointing at the selected element.

5. The training system of claim 1, wherein:
the virtual world includes an operable object; and
the trainer console further allowing the trainer to operate the operable object.

6. The training system of claim 5, further comprising a trainee control that allows the trainee to operate the operable object.

7. The training system of claim 1, wherein the orientation sensor is based on at least one of:
a gyroscope included in the virtual reality headset;
a camera included in the virtual reality headset for capturing visual features within a real space accommodating the trainee; or
cameras positioned within a real space accommodating the trainee and observing visual features on the virtual reality headset or trainee's head.

8. The training system of claim 1, wherein the at least one nonvolatile storage device that stores the digital representation of the three-dimensional virtual world forms part of at least one of:
the virtual reality headset;
the trainer console; or
a server that communicates with the virtual reality headset and the trainer console.

9. The training system of claim 1, wherein the image generator is included in at least one processor of at least one of:
the virtual reality headset;
the trainer console; or
a server that communicates with t virtual reality headset and the trainer console.
